(19) United States
(12) Patent Application Publication
(10) Pub. No.: US 2011/0163684 A1
(43) Pub. Date: Jul. 7, 2011

(54) DRIVING CIRCUIT OF LIGHT EMITTING DIODE AND LIGHTING APPARATUS USING THE SAME

(75) Inventors: Ching-Ju Li, Taipei County (TW); Hao-Yuan Wang, Taipei County (TW)

(73) Assignee: Cal-Comp Electronics & Communications Company Limited, Taipei County (TW)

(21) Appl. No.: 12/712,204

(22) Filed: Feb. 25, 2010

(30) Foreign Application Priority Data
Jan. 4, 2010 (TW) 99100022

(51) Int. Cl. H05B 37/02

(52) U.S. Cl. 315/254; 315/250

(57) ABSTRACT

A driving circuit of light emitting diodes (LEDs) and a lighting apparatus using the same are provided in the application. The driving circuit includes a rectifier unit, an isolation element, a processing unit and a voltage converter circuit. The rectifier unit is coupled to a triac dimmer and outputs a first operation voltage. The processing unit detects a conducting condition of the triac dimmer according to a voltage waveform of the first operation voltage and outputs a pulse width modulation signal to drive the LEDs according to the detected conduction condition, so that flash problems of the LEDs caused by operation voltage variation are prevented.

### CROSS-REFERENCE TO RELATED APPLICATION

This application claims the priority benefit of Taiwan application serial no. 99100022, filed on Jan. 4, 2010. The entirety of the above-mentioned patent application is hereby incorporated by reference herein and made a part of specification.

### BACKGROUND OF THE APPLICATION

1. Field of the Application

The present application relates to a driving circuit of light emitting diodes. More particularly, the present application relates to a driving circuit capable of mitigating a flash phenomenon of light emitting diodes.

2. Description of Related Art

Light emitting diodes (LEDs) have features of small-size, power-saving and high durability, and as fabrication processes thereof become mature, price of the LEDs decreases, so that products using the LEDs as light sources are popular in recent years. Along with a general trend of energy-saving and carbon-reducing, the LED gradually becomes a new generation light source. Since the LED has a low operation voltage and is capable of actively emitting light with a certain brightness, wherein the brightness thereof can be adjusted by voltage or current, and meanwhile the LED has features of impact resistance, anti-vibration and long lifespan (100,000 hours), the LED is widely used in various terminal equipments, such as vehicle headlamps, traffic lights, text displays, billboards and large screen video displays, and domains such as general level architectural lighting and liquid crystal display (LCD) backlight, etc.

A conventional lamp can be dimmed through a triac dimmer, and the triac dimmer and the lamp used in a house can be separately set, for example, the triac dimmer can be set on a wall, so that a user can conveniently adjust a light intensity. Since the triac dimmer is only suitable for adjusting a resistive lamp, and is not suitable for directly adjusting the brightness of the LED, when an LED lamp is used to directly replace the conventional lamp, a flash phenomenon is generated due to different driving methods of the conventional lamp and the LED lamp.

### SUMMARY OF THE APPLICATION

The present application is directed to a driving circuit of light-emitting diodes (LEDs), in which a triangle waveform is compared with a waveform of an output voltage of a triac dimmer to deduce a conducting condition (i.e. a delay angle) of the triac dimmer, and then a corresponding pulse width modulation (PWM) signal is selected to drive a voltage converter circuit, so as to drive the LEDs. In this way, voltages of the LEDs can be accurately adjusted, so as to control currents of the LEDs, and since a brightness of the LED is controlled by the current, the converted PWM signal can mitigate a problem that a conventional analog circuit cannot accurately adjust the currents of the LEDs.

Accordingly, the present application provides a driving circuit of light emitting diodes (LEDs), which is adapted to receive an alternating current (AC) power adjusted by a triac dimmer to drive an LED unit. The driving circuit includes a rectifier unit, an isolation element, a processing unit and a voltage converter circuit. The rectifier unit rectifies the AC power to output a first operation voltage. The isolation element is coupled to the rectifier unit, and is used for receiving the first operation voltage to output a second operation voltage. The processing unit is coupled to the rectifier unit, and detects a conducting condition of the triac dimmer according to a voltage waveform of the first operation voltage and outputs a pulse width modulation (PWM) signal according to the conducting condition. The voltage converter circuit is coupled to the isolation element and the processing unit, and converts the second operation voltage into a driving voltage according to the PWM signal, so as to drive the LED unit.

In an embodiment of the present application, the isolation element is a diode, wherein an anode of the diode is coupled to the rectifier unit, and a cathode of the diode is coupled to the voltage converter circuit. The isolation element can also be a direct current (DC) transformer. The driving circuit further includes a capacitor coupled between a common node of the isolation element and the voltage converter circuit and the ground.

In an embodiment of the present application, the processing unit includes a comparator, a determining unit and a pulse width modulator. A positive input terminal of the comparator is coupled to the first operation voltage, and a negative input terminal of the comparator is coupled to a signal source. The determining unit is coupled to an output terminal of the comparator, and determines the conducting condition of the triac dimmer according to an output of the comparator. The pulse width modulator is coupled to the determining unit, and is used for outputting the PWM signal. The determining unit adjusts a duty cycle of the PWM signal according to the conducting condition and a look-up table. The look-up table records a corresponding relationship between the conducting condition of the triac dimmer and the duty cycle of the PWM signal. The signal source is, for example, a triangle wave signal source or a DC reference voltage.

In an embodiment of the present application, the rectifier unit is a bridge rectifier, and the processing unit can be implemented by an application-specific integrated circuit (ASIC). The triac dimmer is a tri-electrode AC switch (TRIAC), and the voltage converter circuit is a buck circuit.

The present application further provides a lighting apparatus, which is adapted to receive an AC power adjusted by a triac dimmer for lighting. The lighting apparatus includes an LED unit and a driving circuit. The driving circuit is coupled to the triac dimmer and the LED unit, and includes a rectifier unit, an isolation element, a processing unit and a voltage converter circuit. The rectifier unit rectifies the AC power to output a first operation voltage. The isolation element is coupled to the rectifier unit, and is used for receiving the first operation voltage to output a second operation voltage. The processing unit is coupled to the rectifier unit, and detects a conducting condition of the triac dimmer according to a voltage waveform of the first operation voltage and outputs a pulse width modulation (PWM) signal according to the conducting condition. The voltage converter circuit is coupled to the isolation element and the processing unit, and converts the second operation voltage into a driving voltage according to the PWM signal, so as to drive the LED unit.

According to the above descriptions, in the present application, the waveform of the output voltage of the triac dimmer is used to detect a delay angle of the triac dimmer, so as to adjust the PWM signal used for adjusting a brightness of the LEDs, so that the LEDs can obtain a stable PWM signal to avoid a flash problem.

In order to make the aforementioned and other features and advantages of the present application comprehensible, several exemplary embodiments accompanied with figures are described in detail below.

### BRIEF DESCRIPTION OF THE DRAWINGS

The accompanying drawings are included to provide a further understanding of the application, and are incorporated in and constitute a part of this specification. The drawings illustrate embodiments of the application and, together with the description, serve to explain the principles of the application.

FIG. 1 is a circuit schematic diagram of a lighting apparatus according to an embodiment of the present application.

FIG. 2 is a circuit diagram of a processing unit 130.

FIG. 3 is a waveform diagram of a first operation voltage and an alternating current (AC) power according to an embodiment of the present application.

FIG. 4 is a diagram illustrating signal waveforms of a pulse width modulation (PWM) signal CS and a first operation voltage FV.

### DESCRIPTION OF THE EMBODIMENTS

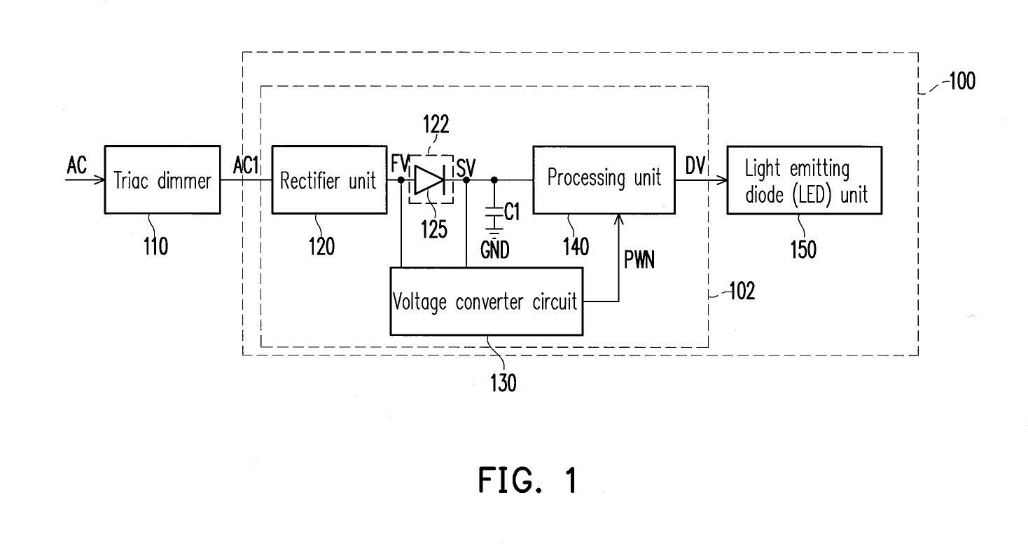

Referring to FIG. 1, FIG. 1 is a circuit schematic diagram of a lighting apparatus according to an embodiment of the present application. The lighting apparatus 100 includes a driving circuit 102 and a light-emitting diode (LED) unit 150. Wherein, the driving circuit 102 is coupled to a triac dimmer 110 and the LED unit 150, and is used for receiving an alternating current (AC) power AC adjusted by the triac dimmer 110 to drive the LED unit 150. The triac dimmer 110 is, for example, a tri-electrode AC switch (TRIAC), which can be used to limit a waveform of the AC power AC according to a conducting condition set by a user, so as to generate an AC power AC1. The driving circuit 102 adjusts a brightness of the LED unit 150 according to the AC power AC1.

The driving circuit 102 mainly includes a rectifier unit 120, an isolation element 122, a processing unit 130 and a voltage converter circuit 140. The rectifier unit 120 is coupled to the triac dimmer 110, the isolation element 122 and the processing unit 130. The voltage converter circuit 140 is coupled to the isolation element 122, the processing unit 130 and the LED unit 150. The rectifier unit 120 is, for example, a bridge rectifier, and is used for rectifying the AC power AC1 to output a first operation voltage FV to the isolation element 122 and the processing unit 130. The isolation element 122 is, for example, a diode 125, wherein an anode of the diode 125 is coupled to the rectifier unit 120, and a cathode of the diode 125 is coupled to the voltage converter circuit 140. The diode 125 receives the first operation voltage FV and output a second operation voltage SV to the voltage converter circuit 140 and the processing unit 130 to serve as an operation power for the voltage converter circuit 140 and the processing unit 130. A capacitor C1 is coupled between an output terminal of the isolation element 122 and the ground terminal GND to achieve a voltage-stabilizing effect. In another embodiment of the present application, the isolation element 122 can also be a direct current (DC) transformer.

The processing unit 130 detects a conducting condition (i.e. a delay angle, wherein the greater the delay angle is, the longer time the triac dimmer 110 is turned off) of the triac dimmer 110 according to a voltage waveform of the first operation voltage FV, so as to deduce a light intensity required by the user. Then, the processing unit 130 adjusts a duty cycle of a pulse width modulation (PWM) signal PWM according to the detected conducting condition. The voltage converter circuit 140 adjusts voltage and current of a driving voltage DV according to the duty cycle of the PWM signal PWM, so as to adjust the brightness of the LED unit 150. The LED unit 150 can be formed by one or a plurality of LEDs connected in series or parallel, which is not limited by the present application. The triac dimmer 110 can also be a different type of dimmer according to a design requirement, for example, a bi-directional thyristor or a field-control thyristor.

A look-up table can be set in the processing unit 130 for recording a corresponding relationship between the duty cycle of the PWM signal PWM and different conducting conditions, and the processing unit 130 can directly adjust the duty cycle of the PWM signal PWM according to the conducting condition of the triac dimmer 110, so as to control the brightness of the LED unit 150. An example of the look-up table is as follows:

TABLE ONE

| Conducting condition | |
|---|---|
| of the triac dimmer | Pulse width |
| (delay angle) | modulation signal |
| 45 degrees | A |
| 90 degrees | B |
| 120 degrees | C |
| . . . | . . . |

The processing unit 130 can directly select a corresponding PWM signal PWM according to the above table one and output it to the voltage converter circuit 140, wherein A, B and C . . . respectively represents the PWM signals PWM having different duty cycles. It should be noticed that the above table one is only an example of the look-up table, and the present application is not limited thereto.

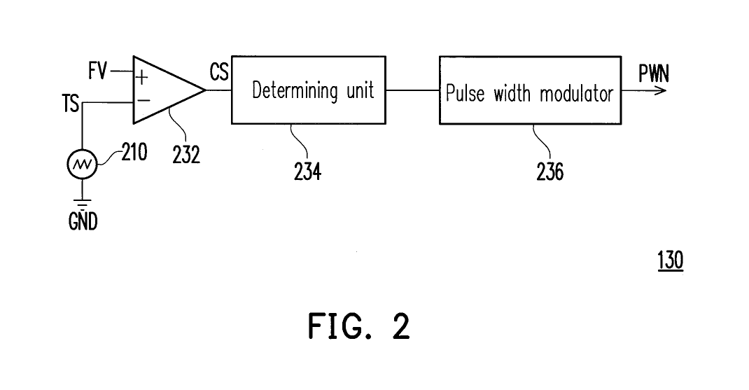

An internal circuit structure of the processing unit 130 is shown in FIG. 2, FIG. 2 is a circuit diagram of the processing unit 130. The processing unit 130 includes a comparator 232, a determining unit 234 and a pulse width modulator 236. A positive input terminal of the comparator 232 is coupled to the first operation voltage FV, and a negative input terminal of the comparator 232 is coupled to a signal source 210. Since a frequency of a triangle wave signal TS output by the signal source 210 is far greater than a frequency of the AC power AC, and a voltage level thereof is greater than zero (ground level), an output terminal of the comparator 232 can output a PWM signal CS having a duty cycle varied along with the first operation voltage FV. When the PWM signal CS is disabled, it represents that the triac dimmer 110 is in a turned off state (i.e. the first operation voltage FV has a low voltage level), and when the PWM signal CS is enabled (a pulse signal is generated), it represents that the triac dimmer 110 is in a turned on state. Therefore, the conducting condition (i.e. the delay angle) of the triac dimmer 110 can be determined according to a waveform variation of the PWM signal CS. In other words, a voltage waveform of the first operation voltage FV can be determined according to the waveform variation of the PWM signal CS.

The determining unit 234 is coupled to the output terminal of the comparator 232, and determines the conducting condition of the triac dimmer 110 according to the PWM signal CS output by the comparator 232. Then, determining unit 234 adjusts the PWM signal PWM output by the pulse width modulator 236 according to the detected conducting condition of the triac dimmer 110 and the look-up table. For example, the greater the delay angle is, the smaller the duty cycle of the PWM signal PWM is.

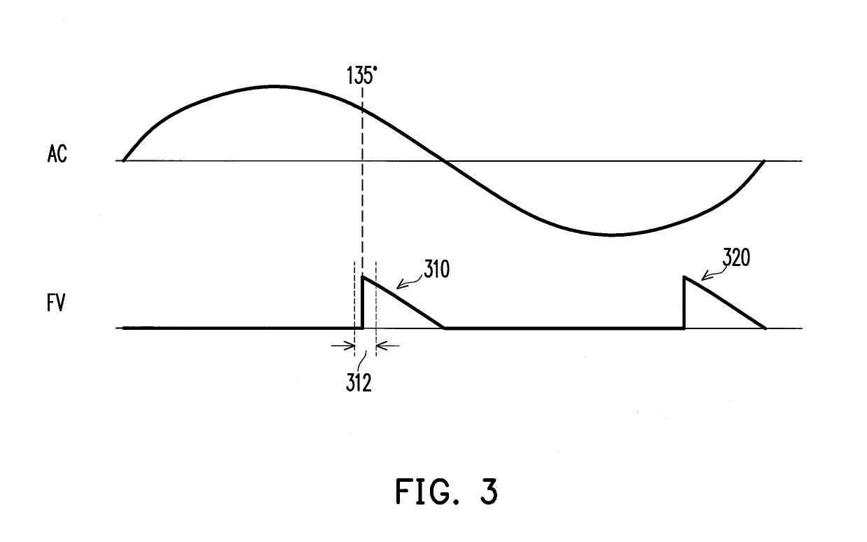

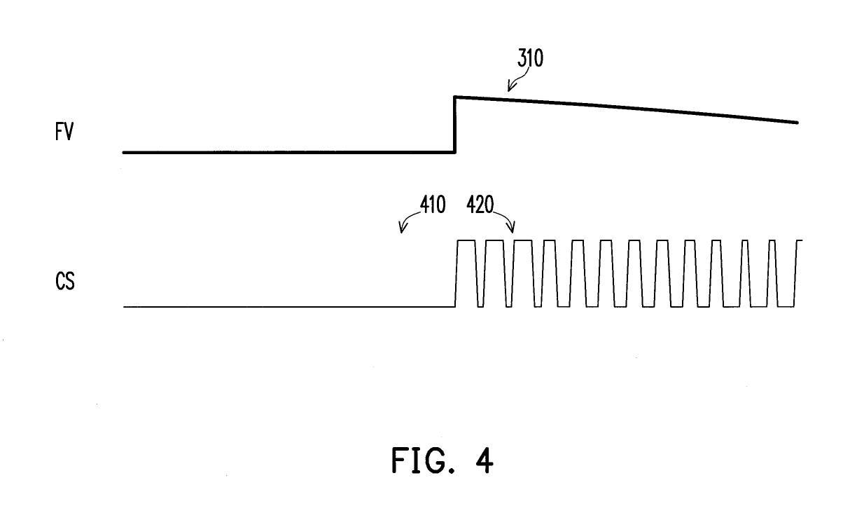

Then, a corresponding relationship between the first operation voltage FV and the PWM signal CS is described with reference of a waveform diagram. Referring to FIG. 3 and FIG. 4, FIG. 3 is a waveform diagram of the first operation voltage FV and the AC power AC according to an embodiment of the present application. The first operation voltage FV is a voltage signal generated after the AC power AC is processed by the triac dimmer 110 and the rectifier unit 120. In FIG. 3, the delay angle of the triac dimmer 110 is assumed to be 135 degrees. As shown in FIG. 3, after a phase of the AC power AC is greater than 135 degrees, the triac dimmer 110 is turned on, so that the waveform (i.e. a signal waveform 310) of the first operation voltage FV is the same to that of the AC power AC. During a next half cycle of the AC power AC, the first operation voltage FV correspondingly generates a signal waveform 320.

The signal waveform 310 within a region 312 is taken as an example to further describe the corresponding relationship of the signal waveforms between the PWM signal CS and the first operation voltage FV. Referring to FIG. 4, FIG. 4 is a diagram illustrating signal waveforms of the PWM signal CS and the first operation voltage FV. When the triac dimmer is not turned on, the first operation voltage FV has the low voltage level, so that the PWM signal CS output by the comparator 232 is also at the low voltage level (disabled), for example, a signal waveform 410. When the triac dimmer 110 is turned on, the voltage level of the first operation voltage FV is varied along with the AC power AC (i.e. the signal waveform 130). Now, the PWM signal CS output by the comparator 232 after the comparator 232 compares the triangle wave signal TS with the first operation voltage FV can generate a corresponding pulse (for example, the signal waveform 420), and a duty cycle of the pulse is varied along with the voltage level of the signal waveform 310. The determining unit 234 can determine a turned on time of the triac dimmer 110 according to the waveform variation (i.e. a time point of generating the signal waveform 420) of the PWM signal CS, and can accordingly deduce the conducting condition (delay angle) of the triac dimmer 110, and further control the pulse width modulator 236 to output the corresponding PWM signal PWM to the voltage converter circuit 140.

Since the processing unit 130 first determines the delay angle of the triac dimmer 110 according to the voltage waveform of the first operation voltage FV, and then correspondingly adjusts the duty cycle of the PWM signal PWM, the PWM signal PWM is rather stable, and is not drifted or becomes unstable due to the waveform variation of the first operation voltage FV. Namely, the duty cycle of the PWM signal PWM is only varied along with the delay angle of the triac dimmer 110. In this way, the brightness of the LED unit 150 can be more stable, so as to avoid a flash phenomenon.

Moreover, it should be noticed that the processing unit 130 can be implemented by an application-specific integrated circuit (ASIC). The signal source 210 can be externally connected or can be configured in the ASIC, which is not limited by the present application. The above voltage converter circuit 140 is, for example, a buck circuit. In another embodiment of the present application, the signal source 210 can also output a DC reference voltage, in this case, the comparator 232 can output a signal with a high voltage level or a low voltage level according to the waveform variation of the first operation voltage FV. When the output of the comparator is changed from the low voltage level to the high voltage level, it represents that the triac dimmer 110 is turned on, so that the delay angle of the triac dimmer 110 can also be detected. Moreover, based on a setting of the DC reference voltage, the first operation voltages FV with too small voltage values can be filtered, so as to avoid the flash phenomenon of the LED unit 150 caused by unstable operation voltages.

In summary, in the present application, the processing unit is used to detect the delay angle of the triac dimmer, so as to output the stable PWM signal to adjust the brightness of the LEDs. Therefore, the brightness of the LEDs can be relatively stable, and the flash phenomenon caused by variation of the voltage output by the triac dimmer can be avoided.

It will be apparent to those skilled in the art that various modifications and variations can be made to the structure of the present application without departing from the scope or spirit of the application. In view of the foregoing, it is intended that the present application cover modifications and variations of this application provided they fall within the scope of the following claims and their equivalents.

What is claimed is:

1. A driving circuit of light emitting diodes (LEDs) adapted to receive an alternating current (AC) power adjusted by a triac dimmer to drive an LED unit, comprising:
a rectifier unit, for rectifying the AC power to output a first operation voltage;
an isolation element, coupled to the rectifier unit for receiving the first operation voltage to output a second operation voltage;
a processing unit, coupled to the rectifier unit for detecting a conducting condition of the triac dimmer according to a voltage waveform of the first operation voltage, and outputting a pulse width modulation (PWM) signal according to the conducting condition; and
a voltage converter circuit, coupled to the isolation element and the processing unit, converting the second operation voltage into a driving voltage according to the PWM signal, so as to drive the LED unit.

2. The driving circuit of the LEDs as claimed in claim 1, wherein the isolation element is a diode having an anode coupled to the rectifier unit and a cathode coupled to the voltage converter circuit.

3. The driving circuit of the LEDs as claimed in claim 1, wherein the isolation element is a direct current (DC) transformer having one end coupled to the rectifier unit and another end coupled to the voltage converter circuit.

4. The driving circuit of the LEDs as claimed in claim 1, wherein the processing unit comprises:
a comparator, having a positive input terminal coupled to the first operation voltage, and a negative input terminal coupled to a signal source;
a determining unit, coupled to an output terminal of the comparator for determining the conducting condition of the triac dimmer according to an output of the comparator; and
a pulse width modulator, coupled to the determining unit, for outputting the PWM signal, wherein the determining unit adjusts a duty cycle of the PWM signal according to the conducting condition and a look-up table,
wherein the look-up table records a corresponding relationship between the conducting condition of the triac dimmer and the duty cycle of the PWM signal.

5. The driving circuit of the LEDs as claimed in claim 1, wherein the signal source is a triangle wave signal source.

6. The driving circuit of the LEDs as claimed in claim 1, wherein the signal source is a DC reference voltage.

7. The driving circuit of the LEDs as claimed in claim 1, wherein the rectifier unit is a bridge rectifier.

8. The driving circuit of the LEDs as claimed in claim 1, further comprising:
a capacitor, coupled between a common node of the isolation element and the voltage converter circuit and the ground.

9. The driving circuit of the LEDs as claimed in claim 1, wherein the processing unit is an application-specific integrated circuit (ASIC).

10. The driving circuit of the LEDs as claimed in claim 1, wherein the triac dimmer is a tri-electrode AC switch (TRIAC).

11. The driving circuit of the LEDs as claimed in claim 1, wherein the voltage converter circuit is a buck circuit.

12. A lighting apparatus adapted to receive an AC power adjusted by a triac dimmer for lighting, comprising:
an light emitting diode (LED) unit; and
a driving circuit, coupled to the triac dimmer and the LED unit, and comprising:
a rectifier unit, for rectifying the AC power to output a first operation voltage;
an isolation element, coupled to the rectifier unit for receiving the first operation voltage to output a second operation voltage;
a processing unit, coupled to the rectifier unit for detecting a conducting condition of the triac dimmer according to a voltage waveform of the first operation voltage, and outputting a pulse width modulation (PWM) signal according to the conducting condition; and
a voltage converter circuit, coupled to the isolation element and the processing unit for converting the second operation voltage into a driving voltage according to the PWM signal, so as to drive the LED unit.

13. The lighting apparatus as claimed in claim 12, wherein the isolation element is a diode having an anode coupled to the rectifier unit and a cathode coupled to the voltage converter circuit.

14. The lighting apparatus as claimed in claim 12, wherein the isolation element is a direct current (DC) transformer having one end coupled to the rectifier unit and another end coupled to the voltage converter circuit.

15. The lighting apparatus as claimed in claim 12, wherein the processing unit comprises:
a comparator, having a positive input terminal coupled to the first operation voltage, and a negative input terminal coupled to a signal source;
a determining unit, coupled to an output terminal of the comparator for determining the conducting condition of the triac dimmer according to an output of the comparator; and
a pulse width modulator, coupled to the determining unit, for outputting the PWM signal, wherein the determining unit adjusts a duty cycle of the PWM signal according to the conducting condition and a look-up table,
wherein the look-up table records a corresponding relationship between the conducting condition of the triac dimmer and the duty cycle of the PWM signal.

16. The lighting apparatus as claimed in claim 12, wherein the signal source is a triangle wave signal source.

17. The lighting apparatus as claimed in claim 12, wherein the signal source is a DC reference voltage.

18. The lighting apparatus as claimed in claim 12, wherein the rectifier unit is a bridge rectifier.

19. The lighting apparatus as claimed in claim 12, further comprising:
a capacitor, coupled between a common node of the isolation element and the voltage converter circuit and the ground.

20. The lighting apparatus as claimed in claim 12, wherein the processing unit is an application-specific integrated circuit (ASIC).

21. The lighting apparatus as claimed in claim 12, wherein the triac dimmer is a tri-electrode AC switch (TRIAC).

22. The lighting apparatus as claimed in claim 12, wherein the voltage converter circuit is a buck circuit.
